(19) United States
(12) Patent Application Publication
(10) Pub. No.: US 2009/0319088 A1
(43) Pub. Date: Dec. 24, 2009

(54) METHODS AND APPARATUS FOR CONTROLLING OPERATION OF A CONTROL DEVICE

(76) Inventors: Richard Reed, Charlottesville, VA (US); William Henry Lueckenbach, Charlottesville, VA (US)

Correspondence Address: General Electric Company;GE Global Patent Operation, PO Box 861, 2 Corporate Drive, Suite 648, Shelton, CT, 06484, US

(21) Appl. No.: 12/141,189

(22) Filed: Jun. 18, 2008

(51) Int. Cl. G05D 7/06; F16K 31/02; F16K 31/72

(52) U.S. Cl. 700/282; 251/129.04

(57) ABSTRACT

Methods and apparatus for preventing stiction in control devices are provided. In one aspect, a method for controlling dither in a control device includes coupling a signal input of the control device to an analog output module, generating an output signal, and transmitting the output signal from the analog output module to the signal input, wherein the output signal causes the control device to oscillate about an output position to facilitate preventing stiction within the control device.

### FIELD OF THE INVENTION

The subject matter disclosed herein relate generally to a control for a flow control device and, more particularly, to methods and an apparatus for using dithering to facilitate preventing stiction in a flow control device.

Flow control devices, such as valves, may become locked in a particular position if left in that position for an extended period of time and/or in certain environments. Such locking is known as “stiction,” which is a resistance to a start of motion. Stiction may cause a valve port stem or solenoid pintle to move suddenly at an unknown rate at a start of a repositioning movement or to move in an inconsistent manner while being repositioned. Moreover, stiction may prevent the stem or pintle from moving altogether. To avoid stiction, at least some known valves use dithering. Dithering acts to oscillate the valve port stem about the output position.

At least some known valves include built in dithering mechanisms and/or controls. Moreover, at least some known valves may include dithering mechanisms and/or controls that may be controlled by an application program that controls the functionality of the valves. However, controls included in the hardware may not be configurable remotely, or may not include any configurability. In addition, application programs may not allow a user to alter the dithering settings. Further, each of these solutions necessitates additional or more expensive hardware and/or software which adds considerably to the cost of operation. As such, there is a need for an apparatus that enables a user to control the analog output to a valve, including controlling dithering settings such as frequency and/or amplitude. Moreover, it is desirable to enable a user to program settings such as frequency and/or amplitude to output to control devices that require different dithering settings.

### BRIEF DESCRIPTION OF THE INVENTION

In one aspect, a method is provided for controlling dither in a control device. The method includes coupling a signal input of the control device to an analog output module, generating an output signal, and transmitting the output signal from the analog output module to the signal input, wherein the output signal causes the control device to oscillate about an output position to facilitate preventing stiction within the control device.

In another aspect, an apparatus is provided for controlling dither in a control device. The apparatus includes a processor, a memory, and a system bus coupling the memory to the processor. The apparatus is configured to be coupled to a signal input of the control device and is further configured to generate an output signal, and transmit the output signal to the signal input of the control device, wherein the output signal causes the control device to oscillate about an output position.

In another aspect, a method is provided for controlling dither in a control device. The method includes coupling a signal input of the control device to an analog output module, generating an output signal, and transmitting the output signal from the analog output module to the signal input, wherein the output signal is based at least partially on at least one of a predetermined dither frequency and a predetermined dither amplitude, and wherein the output signal causes the control device to oscillate about an output position to facilitate preventing stiction within the control device.

### BRIEF DESCRIPTION OF THE DRAWINGS

Aspects of the invention may be better understood by referring to the following descriptions in conjunction with the accompanying drawings.

FIG. 1 is a block diagram of an exemplary apparatus that may be used to control dithering of a flow control device; and

FIG. 2 is a flowchart showing an exemplary method for controlling dithering of a flow control device using the apparatus shown in FIG. 1.

### DETAILED DESCRIPTION OF THE INVENTION

Set forth below are descriptions of exemplary methods and an apparatus for use in implementing dithering in valves, and which provide a number of technical effects. One such technical effect is to provide methods and an apparatus that implement dither in control devices, such as valves, by outputting a dithered output signal from an analog output module.

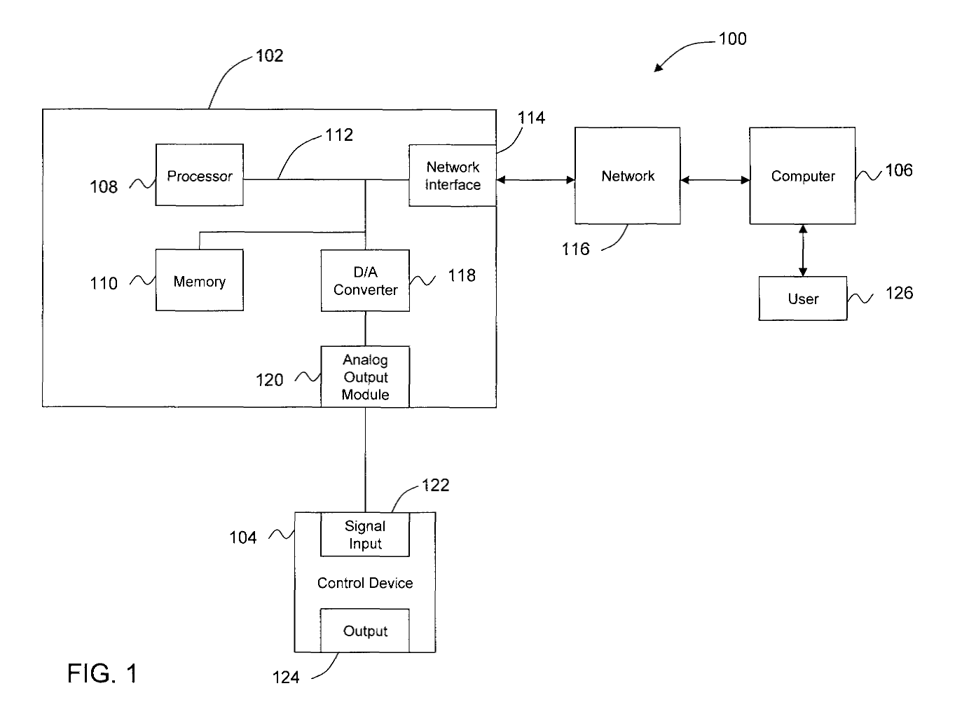

FIG. 1 is a block diagram showing an embodiment of a system 100 that includes an analog output module 102, a control device 104, and a computer 106, which may be implemented as a PLC. System 100 may be implemented on many different platforms and may utilize many different architectures. The architecture shown in FIG. 1 is exemplary only. Module 102 includes a processor 108 that executes functions. For example, processor 108 may execute, but is not limited to executing, user logic and function block executions, input/output (I/O) scanning, and/or communications to other devices, such as control device 104 and/or computer 106. Module 102 also includes a memory 110 that is electrically coupled to processor 108 via a system bus 112. In one embodiment, memory 110 includes an operating system for apparatus 102, a user program, and/or data. Module 102 also includes a network interface 114 that facilitates communicating with a network 116 connecting module 102 and computer 106.

Moreover, in the exemplary embodiment, module 102 includes a digital-to-analog (D/A) converter 118 that is electrically coupled to processor 108 and/or memory 110 via system bus 112. D/A converter 118 receives digital commands in the form of, for example, a 16-bit value, and converts the digital command into an analog output signal. D/A converter 118 transmits, as output, the analog output signal to flow control device 104.

In one embodiment, control device 104 includes a valve having a signal input 120 and an output 122, such as a valve port. Control device 104 receives the analog output signal from analog output module 102 and operates according to, or in response to, the analog output signal.

Computer 106 is electrically coupled to network 116. In one embodiment, computer 106 is implemented as a PLC. Network 116 includes the physical media and intermediate devices (not shown), such as backplanes, routers, and/or switches, that connect computer 106 to module 102. In one embodiment, network 116 is a wide area network (WAN), such as the Internet. In an alternative embodiment, network 116 is a local area network (LAN), such as an intranet. In the exemplary embodiment, a user 124 accesses an intranet or the Internet to gain access to module 102 and/or computer 106. In one embodiment, computer 106 includes a web browser (not shown), and module 102 is accessible to computer 106 via the Internet. Computer 106 may be connected to network 116 through any suitable interface including, without limitation, a different network, a dial-in connection, a cable modem, a wireless network, and/or a high-speed Integrated Services Digital Network (ISDN) line. Computer 106 may be implemented as any device capable of connecting to network 116, and may include a web-based telephone or other web-based connectable equipment. Computer 106 executes a user application that provides a mechanism for user 124 to display and/or control apparatus data using a standard web browser.

During operation, user 124 inputs a dithering frequency and/or a dithering amplitude, such as a default, predetermined, or selected dithering frequency and/or a default, predetermined, or selected dithering amplitude, into computer 106. Computer 106 then transmits the dithering parameters to module 102 via network 116. Processor 108 generates a digital output command and transmits the designated output command to D/A converter 118 as a digital command via system bus 112. More specifically, processor 108 generates a dithered digital output command based on at least one of the dithering amplitude and the dithering frequency, and transmits the dithered digital output command to D/A converter 118. D/A converter 118 converts the digital output command into an analog output signal and transmits the analog output signal to signal input 120. Alternatively, user 124 may elect to input only a predetermined dithering frequency or only a predetermined dithering amplitude. In such a case, processor 108 may also base the calculation of the digital output command on default values for the dithering frequency and/or the dithering amplitude. Control device 104 then generates an output based on the analog output signal.

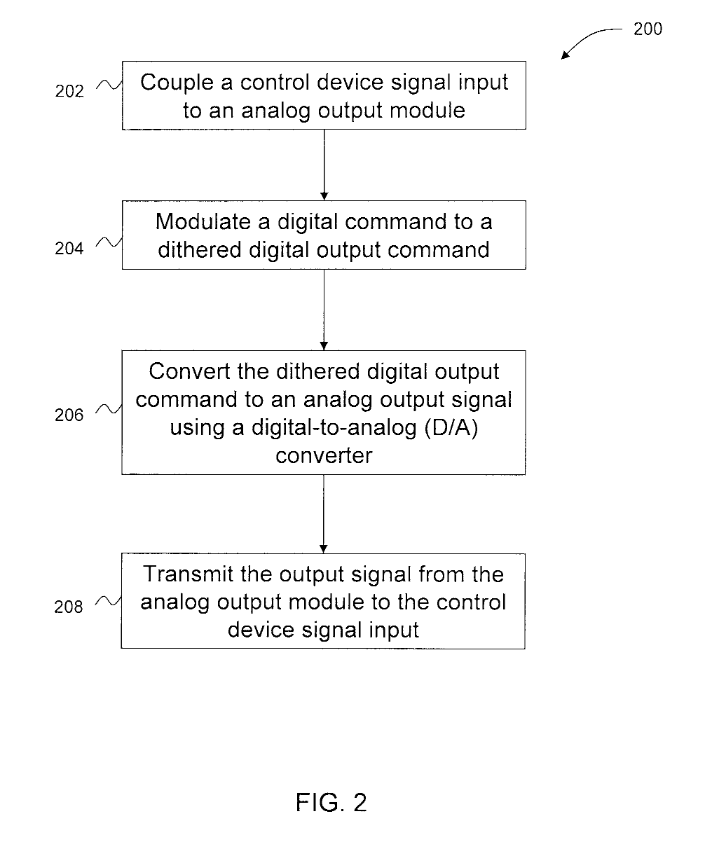

FIG. 2 is a flowchart showing an exemplary embodiment of a method 200 for initiating and controlling dither in a control device, such as control device 104 (shown in FIG. 1). Control device 104 may be implemented as, for example, a valve including a valve port. Dither is initiated and controlled by an analog output module, such as module 102 (shown in FIG. 1). Initially, a user, such as user 124 (shown in FIG. 1) inputs a dithering frequency and/or a dithering amplitude, such as a default, predetermined, or selected dithering frequency and/or a default, predetermined, or selected dithering amplitude, using computer 106 (shown in FIG. 1). Computer 106 may be implemented as, for example, a PLC. In the exemplary embodiment, signal input 120 (shown in FIG. 1) of control device 104 is coupled 202 to module 102. More specifically, signal input 120 is coupled to D/A converter 118 of module 102.

Module 102 receives a base output command value as well as the dithering frequency and/or dithering amplitude from computer 106. Processor 108 (shown in FIG. 1) modulates 204 a digital output command to D/A converter 118 based on the output command value, the received dithering frequency, and the received dithering amplitude, and transmits the final digital output command to D/A converter 118 (shown in FIG. 1). In the exemplary embodiment, the digital output command is based on the predetermined dithering frequency and/or the predetermined dithering amplitude. In an alternative embodiment, the digital output command is based on the predetermined dithering frequency and a default dithering amplitude. In a further alternative embodiment, the digital output command is based on a default dithering frequency and the predetermined dithering amplitude. In yet another alternative embodiment, the digital output command is based on a default dithering frequency and a default dithering amplitude. D/A converter 118 determines an analog output signal by converting 206 the digital output command into the analog output signal. In one embodiment, D/A converter 118 converts a 16-bit digital output command into the analog output signal. In alternative embodiments, digital output commands including more than 16 bits or fewer than 16 bits may be converted into analog output signals by D/A converter 118. In the exemplary embodiment, the analog output signal oscillates about an original output value.

Once the analog output signal is determined, D/A converter 118 transmits 208 the analog output signal to signal input 120. Control device 104 uses the output signal to control the output of output 122 about an output position that is based on an original output value. In one embodiment, control device 104 oscillates output 122 about the output position with the predetermined dithering frequency and with a default dithering amplitude, based on the analog output signal. In an alternative embodiment, control device 104 oscillates output 122 about the output position with a default dithering frequency and with the predetermined dithering amplitude, based on the analog output signal. In a further alternative embodiment, control device 104 oscillates output 122 about the output position with the predetermined dithering frequency and with the predetermined dithering amplitude, based on the analog output signal. In a further alternative embodiment, control device 104 oscillates output 122 about the output position with the default dithering frequency and with the default dithering amplitude, based on the analog output signal. The default dithering frequency and/or the default dithering amplitude may be preset within control device 104 or may be preset within module 102 and transmitted to control device 104 via signal input 122.

In summary, in one embodiment, a method for controlling dither in a control device is provided. The method includes coupling a signal input of the control device, such as a valve, to an analog output module, and transmitting an output signal from the analog output module to the signal input. In one embodiment, a digital output command is converted into the output using a digital-to-analog (D/A) converter.

Moreover, in one embodiment, the method includes transmitting the output signal from the analog output module to the signal input. The output signal causes the control device to oscillate about an output position to facilitate preventing stiction within the control device.

In one embodiment, the digital output command is calculated based on a predetermined dithering frequency. In an alternative embodiment, the digital output command is calculated based on a predetermined dithering amplitude. In a further alternative embodiment, the digital output command is calculated based on a predetermined dithering frequency and a predetermined dithering amplitude.

The above-described methods and apparatus facilitate preventing stiction in output devices by enabling PLC-controlled dithering. Calculating an output signal based on a predetermined dithering frequency and/or a predetermined dithering amplitude using an analog output module of a PLC facilitates reducing the cost of assembling and maintaining a system by avoiding use of more expensive output devices that include a dither function and/or additional software and hardware necessary to implement computer-controlled dithering. Such savings are further facilitated through the use of existing PLC to output device couplings.

Exemplary embodiments of methods and an apparatus for enabling analog-controlled output device dithering are described above in detail. The methods and apparatus are not limited to the specific embodiments described herein but, rather, steps of the methods and/or components of the apparatus may be utilized independently and separately from other steps and/or components described herein. Further, the described methods steps and/or apparatus components may also be defined in, or used in combination with, other methods and/or apparatus, and are not limited to practice with only the methods and apparatus as described herein.

As used herein, an element or step recited in the singular and proceeded with the word “a” or “an” should be understood as not excluding a plurality of said elements or steps, unless such exclusion is explicitly recited. Further, references to one embodiment of the present invention are not intended to be interpreted as excluding the existence of additional embodiments that also incorporate the recited features.

While the methods and apparatus have been described in terms of various specific embodiments, those skilled in the art will recognize that the methods and apparatus may be practiced with modification within the spirit and scope of the claims.

What is claimed is:

1. A method for controlling dither in a control device, said method comprising:
coupling a signal input of the control device to an analog output module;
generating an output signal; and
transmitting the output signal from the analog output module to the signal input, the output signal causing the control device to oscillate about an output position to facilitate preventing stiction within the control device.

2. A method in accordance with claim 1, wherein coupling a signal input of the control device to an analog output module comprises coupling a signal input of to the control device to a digital-to-analog (D/A) converter of the analog output module.

3. A method in accordance with claim 1, wherein generating an output signal comprises generating a digital output command.

4. A method in accordance with claim 3, wherein generating an output signal further comprises converting the digital command into the output signal using the digital-to-analog (D/A) converter.

5. A method in accordance with claim 3, wherein generating a digital output command further comprises generating the digital output command based at least partially on a predetermined dithering frequency.

6. A method in accordance with claim 3, wherein generating a digital output command further comprises generating the digital output command based at least partially on a predetermined dithering amplitude.

7. A method in accordance with claim 3, wherein generating a digital output command further comprises generating the digital output command based at least partially on a predetermined dithering frequency and a predetermined dithering amplitude.

8. A method in accordance with claim 3, wherein generating a digital output command further comprises generating the digital output command based at least partially on at least one of a default dithering frequency and a default dithering amplitude.

9. An apparatus for controlling dither in a control device, said apparatus comprising:
a processor;
a memory; and
a system bus coupling said memory to said processor, said apparatus configured to be coupled to a signal input of the control device, said apparatus further configured to:
generate an output signal; and
transmit the output signal to the signal input, the output signal causing the control device to oscillate about an output position.

10. An apparatus in accordance with claim 9, wherein said processor is configured to generate a digital output command.

11. An apparatus in accordance with claim 10, further comprising a digital-to-analog (D/A) converter coupled to said system bus, said D/A converter configured to convert the digital output command into the output signal and to transmit the output signal to the signal input of the control device.

12. An apparatus in accordance with claim 9, wherein said processor is configured to generate the digital output command based at least partially on a predetermined dithering frequency.

13. An apparatus in accordance with claim 9, wherein said processor is configured to generate the digital output command based at least partially on a predetermined dithering amplitude.

14. An apparatus in accordance with claim 9, wherein said processor is configured to generate the digital output command based at least partially on a predetermined dithering frequency and a predetermined dithering amplitude.

15. An apparatus in accordance with claim 9, wherein said processor is configured to generated the digital output command based at least partially on at least one of a default dithering frequency and a default dithering amplitude.

16. A method for controlling dither in a control device, said method comprising:
coupling a signal input of the control device to an analog output module;
generating an output signal; and
transmitting the output signal from the analog output module to the signal input, the output signal based at least partially on at least one of a predetermined dither frequency and a predetermined dither amplitude, the output signal causing the control device to oscillate about an output position to facilitate preventing stiction within the control device.

17. A method in accordance with claim 16, wherein coupling a signal input of the control device to an analog output module comprises coupling a signal input of to the control device to a digital-to-analog (D/A) converter of the analog output module.

18. A method in accordance with claim 17, wherein generating an output signal comprises generating a digital output command and converting the digital command into the output signal using the D/A converter.

19. A method in accordance with claim 16, wherein generating a digital output command comprises generating the digital output command based at least partially on at least one of a default dithering frequency and a default dithering amplitude.

20. A method in accordance with claim 16, further comprising receiving, by the analog output module, at least one of the predetermined dither frequency and the predetermined dither amplitude, wherein the predetermined dither frequency and the predetermined dither amplitude are separately configurable.
